(19) United States
(12) Patent Application Publication
(10) Pub. No.: US 2015/0332414 A1
(43) Pub. Date: Nov. 19, 2015

(54) SYSTEM AND METHOD FOR PREDICTING ITEMS PURCHASED BASED ON TRANSACTION DATA

(71) Applicant: MASTERCARD INTERNATIONAL INCORPORATED, Purchase, NY (US)

(72) Inventors: Kenny Unser, Fairfield, CT (US); Serge Bernard, Danbury, CT (US); Nikhil A. Malgatti, Stamford, CT (US)

(73) Assignee: MASTERCARD INTERNATIONAL INCORPORATED, Purchase, NY (US)

(21) Appl. No.: 14/276,561

(22) Filed: May 13, 2014

(51) Int. Cl. G06Q 40/00; G06F 17/30

(52) U.S. Cl. CPC G06Q 40/12; G06F 17/3053; G06F 17/30598; G06F 17/30312

(57) ABSTRACT

A system for analyzing data comprising: an input module for receiving a transaction record corresponding to a product purchase; a database for storing the transaction received by the input module; a computerized predictive model for determining an indicator for the transaction record based on at least one of a customer identifier, a class of merchant, an amount of the transaction, and a terminal identifier, wherein the indicator is indicative of a likelihood of a correct product determination; and one or more processors for: executing the predictive models; and processing the transaction record based upon the indicator determined by the computerized predictive model.

### CROSS-REFERENCE TO RELATED APPLICATIONS

None.

### FIELD OF INVENTION

The present invention relates to financial transaction data and systems and methods for using such data. More particularly, the invention relates to systems and methods for determining items purchased based on financial transaction data that omits direct itemization, and processing such data to provide financial information relating to a customer or merchant.

### BACKGROUND

Corporations and government agencies have a keen interest in any available information regarding the flow of money as it relates to the potential prediction of future purchases and consumer actions. Merchants often want to monitor and review their company and/or business performance to obtain additional clients/customers and increase revenues for their particular business. Many merchants maintain extensive records of business transactions that identify itemized products and their associated invoices, and correlate this information with particular customers in order to obtain relevant business information that may assist a merchant's business decision-making. However, such information is limited to the particular merchant, and without significant knowledge of related customer transactions occurring with other merchants. Thus, a given merchant possesses limited detailed knowledge as to its customers' purchases of items and services associated with other (e.g. competitor or ancillary merchant) stores. Credit card companies, banks and other financial institutions may have knowledge of various payment card transactions, but do not necessarily receive specific records containing itemized invoicing and associated products purchased.

### SUMMARY

A system and method is provided for determining categories and/or types of items purchased based on financial transaction data that omits direct itemization, and processing such data to provide financial information relating to the customer and/or merchant.

In embodiments, systems and computer-implemented methods are provided to determine a category or type of item purchased as part of a given payment card transaction based on applying a predictive model analysis of previous payment card transactions associated with multiple customers and merchants to one or more data parameters of the given payment card transaction.

In embodiments, systems and methods for determining a type or category of product purchased as part of a payment card transaction between a customer and a merchant, comprises receiving at a computer processor, payment card transaction record data, where the transaction record omits direct product purchase itemization data. In one embodiment, the payment card transaction record data may include one or more of a customer identifier, a merchant identifier, and a transaction purchase amount corresponding to a product purchase transaction. A predictive model is used to determine a likelihood indicator that a given type or category of product sold by the merchant matches that of the actual product purchased in the payment card transaction. The transaction record data is analyzed in order to generate one or more score indicators that represent different possible product types or categories of product purchased via the payment card transaction. In one embodiment, the transaction record data analyzed includes one or more of the customer identifier, the transaction purchase amount, and a class of the merchant corresponding to the transaction record, and is compared with historical data of previous payment card transactions, in order to generate one or more score indicators that represent different possible product types or categories of product purchased via the payment card transaction. The system compares the one or more score indicators with a threshold value to generate a score index and selects the indicator having the highest score from the score index as representative of the type or category of product actually purchased in the transaction. The transactions data base may be processed to generate merchant spend profiles and price thresholds that correspond to average prices allocated to particular categories or types of items sold by the merchant. Terminal identifier information of a merchant that identifies the particular POS terminals for which purchase transactions are made may be stored in the database and purchase prices for each transaction analyzed statistically to determine statistical average purchase prices associated with each particular terminal, in order to allocate one or more categories or types of products tending to be purchased at each of said terminals. In one embodiment, the determined average may be calculated as the arithmetic average (mean). In other embodiments, the average may be calculated as the median, mode, geometric mean and/or weighted average. Temporal purchase sequencing of transactions of the customer may be performed over a given time interval and correlated with the transaction record data to determine one or more trends of customer behavior indicative of the likelihood that a given category or type of product sold by the merchant is representative of the type or category of product purchased in the transaction. The system further may be configured to determine and utilize natural price breaks associated with a given merchant based on computerized analysis of aggregate purchase price transaction records associated with the particular merchant.

In another embodiment, a system for analyzing payment card transactions data comprises an input module for receiving a transaction record that may include one or more of a customer identifier, a merchant identifier, and a transaction amount, corresponding to a product purchase transaction, wherein the transaction record omits direct product purchase itemization data. A database is configured to store the transaction record received by the input module. A computerized predictive model is configured to determine a likelihood indicator that a given type or category of product was actually purchased as part of the transaction, based on one or more of the customer identifier, the transaction amount, a class of merchant, an amount of the transaction, and a terminal identifier, wherein the indicator is indicative of a likelihood of a correct product determination. One or more computer processors is configured for: executing the predictive models; and processing the transaction record based upon the indicator determined by the computerized predictive model. The computerized predictive model is constructed through an analytic process that identifies variables in a plurality of transaction records corresponding to purchases, and calculates at least one score based on analysis of the variables, wherein each score is indicative of a likelihood that the transaction record corresponds to a purchase of a particular product type or category. The processor is configured to aggregate transaction records to generate one or more merchant and customer profiles and associate the product categories of a given merchant with an average product price and average transaction amount. The processor may determine one or more variance thresholds for score differentials that exceed a score threshold, and select a highest score as indicative of the type or category of product purchased.

### BRIEF DESCRIPTION OF THE DRAWINGS

FIG. 1 illustrates a system architecture within which some embodiments may be implemented.

FIG. 2 is a partial functional block diagram of an insurance computer system to determine insurance groups and individuals for participation and enrollment in a behavior modification program.

FIG. 3 illustrates a high level block diagram of a system for generating predictive model data linked to determining product type based on transactions data in accordance with an exemplary embodiment.

FIG. 4 illustrates exemplary transaction record data useful in implementing aspects of the present system and method.

FIG. 5 illustrates an exemplary process flow for determining information based on transaction records using predictive modeling.

FIG. 6 illustrates an exemplary process flow for determining product type based on transactions data in accordance with an exemplary embodiment.

FIG. 7 illustrates exemplary data base transactions data on which the system and method of the present disclosure operate for determining a type or category of product purchased as part of a payment card transaction between a customer and a merchant based on a payment card transaction that omits direct itemization in accordance with an exemplary embodiment.

FIG. 8 illustrates exemplary processing functionality for determining a type or category of product purchased as part of a payment card transaction between a customer and a merchant based on a payment card transaction that omits direct itemization in accordance with an exemplary embodiment.

### DETAILED DESCRIPTION

Disclosed herein are processor-executable methods, computing systems, and related processing for the administration, management and communication of data relating to the determination of a category or type of product or service purchased by a customer using a payment card in a given transaction derived from payment card transaction data from customers and merchants, wherein the given payment card transaction record omits itemization. Transaction data may include one or more of customer information, merchant information, and transaction amounts and are processed to identify purchasers of particular properties. Transaction data may be stored in a data base (e.g. a relational data base) and analyzed to link relevant fields within various records to one another in order to determine and establish relationships (e.g. cause and effect, associations and groupings) and links between and among categories of services, customers, merchants, geographic regions, frequencies of services, and the like.

An analytics engine utilizing statistical analyses and techniques applied to the payment card transaction data is implemented to analyze the payment card transactions records to determine relationships, patterns, and trends between and among the various transaction records in order to predict the type and/or category of product (or service) purchased in a given transaction without the benefit of direct itemization of the given transaction. The engine is further configured to ascribe attributes or traits to purchasers based on the payment card transaction data. Based on the payment card transaction data, characteristic traits of the purchasers that relate to specific actions are linked with a particular property in order to provide insight as to the type or category of product (or service) purchased in the given transaction. Furthermore, profiles of purchasers may be generated and those purchasers exhibiting similar purchasing trends or tendencies, and/or geographic regions are grouped together, as are merchants who provide similar services, similar price purchasing, and/or similar geography. The transaction records may be processed and segmented into various categories in order to determine information relating to purchasers of a given property to be determined, purchasing frequencies, and drivers or factors and/or conditions affecting the determined purchased property or frequency of service, by way of non-limiting example.

The analysis engine may utilize independent variables as well as dependent variables representative of one or more purchasing events, customer types or profiles, merchant types or profiles, purchase amounts, and purchasing frequencies, by way of example only. The analysis engine may use models such as regression analysis, correlation, analysis of variances, time series analysis, determination of frequency distributions, segmentation and clustering applied to the transactions data in order to determine and predict the effect particular categories of data have on other categories, and thereby determine drivers of particular actions associated with a given property represented in the transactions data.

The system according to embodiments of the present invention leverages statistical techniques to group merchants and uncover logical breaks in the transaction data, indicative of a particular type or category of purchase, in order to predict the likelihood of a particular purchase. Temporal sequencing analysis of prior known purchases and/or events, and merchant associations determined from analyzing the payment card transaction data is utilized by the system to determine or predict that a given purchase is of a particular type (or category) of product without knowledge of the itemized invoice. In this manner, application of the logic developed using the above process enables customers, markets, and/or service providers to deliver information and meaningful insight relating to various commercial and consumer related applications.

In accordance with an exemplary embodiment, the system and method described herein provide a framework to utilize payment card transactions to provide data representative of actions taken and to predict types or categories of items purchased with respect to one or more properties identifiable from the payment card transaction data. In accordance with an aspect of the present disclosure, a predictive model is developed using the multiplicity of transactions data in the transactions database and application of the analysis engine to determine factors that may affect customer purchases by grouping merchants and determining logical breaks in the transactions data based on price and/or other factors. The system is configured to determine from the transaction data that a given transaction price from a particular terminal of a particular merchant may yield a high probability or likelihood of a certain product (e.g. product type or category) being the subject of the particular transaction. The system is further configured to determine from sequencing of purchases/events as well as the merchants associations and correlations, the likelihoods of related purchases (e.g.: Individuals who purchased a gas grill will most likely buy a gas tank in the near future). The predictive model may be enhanced with additional external data (e.g. merchant transactions information relating to specific purchases, and/or other external data relating to purchase transactions contained in the transactions database) so as to verify the quality of the predictive model and the associations, and/or adapt the predictions, whereby the payment card transactions data is used as predictive data and the particular merchant data (including itemized product(s) purchased in a given transaction) represents the target. Correlation may be accomplished using context sensitive analysis of the transaction data, using information from an entity operating a website or information of historical transactions associated with the user alone, combined, or even with the assistance of a predictive model. The predictive model(s) of the present invention may include one or more of neural networks, Bayesian networks (such as Hidden Markov models), expert systems, decision trees, collections of decision trees, support vector machines, or other systems known in the art for addressing problems with large numbers of variables. In embodiments, the predictive models are trained on prior data and outcomes using a historical database of prior transactions and resulting correlations relating to a same user, different users, or a combination of a same and different users. In embodiments of the present invention, the predictive model may be implemented as part of calculation module or tool.

For a given transaction record that omits direct itemization, analysis of the record is performed using the aforementioned factors and applied back into that particular payment card transaction data, in order to determine or forecast in real time what type or category of product was purchased in that particular transaction.

It is to be understood that a payment card is a card that can be presented by the cardholder (i.e., customer) to make a payment. By way of example, and without limiting the generality of the foregoing, a payment card can be a credit card, debit card, charge card, stored-value card, or prepaid card or nearly any other type of financial transaction card. It is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

A “payment card processing system” or “credit card processing network”, such as the MasterCard network exists, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

A “business classification” is a group of merchants and/or businesses, classified by the type of goods and/or service the merchant and/or business provides. For example, the group of merchants and/or businesses can include merchants and/or businesses which provide similar goods and/or services. In addition, the merchants and/or businesses can be classified based on geographical location, sales, and any other type of classification, which can be used to define a merchant and/or business with similar goods, services, locations, economic and/or business sector, industry and/or industry group.

Determination of a merchant classification or category may be implemented using one or more indicia or merchant classification codes to identify or classify a business by the type of goods or services it provides. For example, ISO Standard Industrial Classification (“SIC”) codes may be represented as four digit numerical codes assigned by the U.S. government to business establishments to identify the primary business of the establishment. Similarly a “Merchant Category Code” or “MCC” is also a four-digit number assigned to a business by an entity that issues payment cards or by payment card transaction processors at the time the merchant is set up to accept a particular payment card. Such classification codes may be included in the payment card transactions records. The merchant category code or MCC may be used to classify the business by the type of goods or services it provides. For example, in the United States, the merchant category code can be used to determine if a payment needs to be reported to the IRS for tax purposes. In addition, merchant classification codes are used by card issuers to categorize, track or restrict certain types of purchases. Other codes may also be used including other publicly known codes or proprietary codes developed by a card issuer, such as NAICS or other industry codes, by way of non-limiting example.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

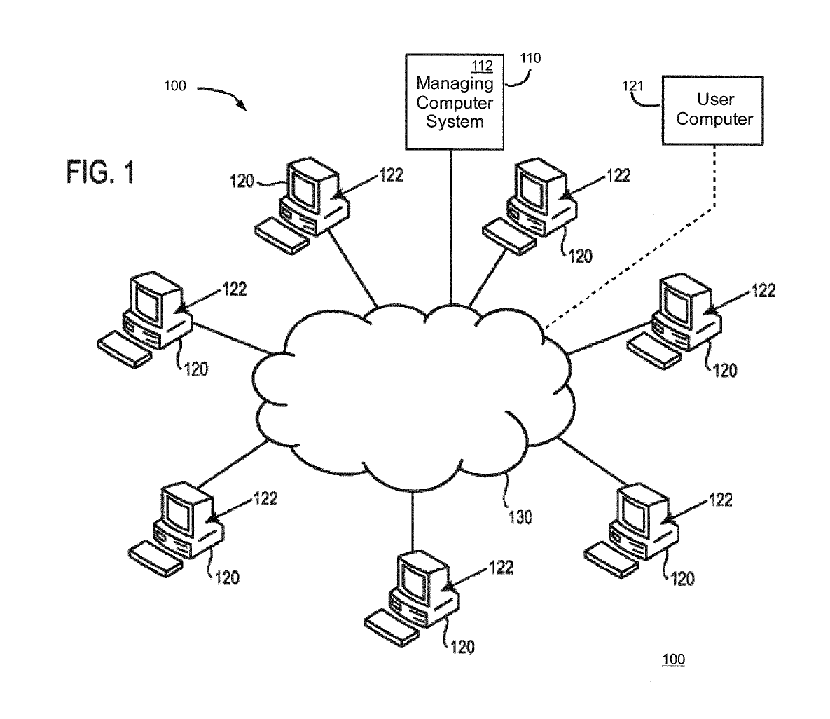

Referring now to FIG. 1, there is shown an exemplary system for providing services based on payment card transactions data according to an embodiment of the disclosure. The system of FIG. 1 includes illustrates a high-level diagram of a system architecture that may be employed in accordance with an exemplary embodiment. As shown in FIG. 1, the system 100 includes a managing computer system 110 that includes a data store or data warehouse for storing payment card transaction records associated with a payment card service provider 112. Each payment transaction performed by a transaction acquirer and/or merchant 122 having a corresponding merchant computer system 120 is transferred to the managing computer system 110 via a network 130 which connects the computer system 120 of the transaction acquirer or merchant 122 with the managing computer system 110 of the payment card service provider 112. The data base stores significant numbers of transaction records, each representing a particular purchase transaction between a respective customer and merchant.

The network 130 can be virtually any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission by way of example.

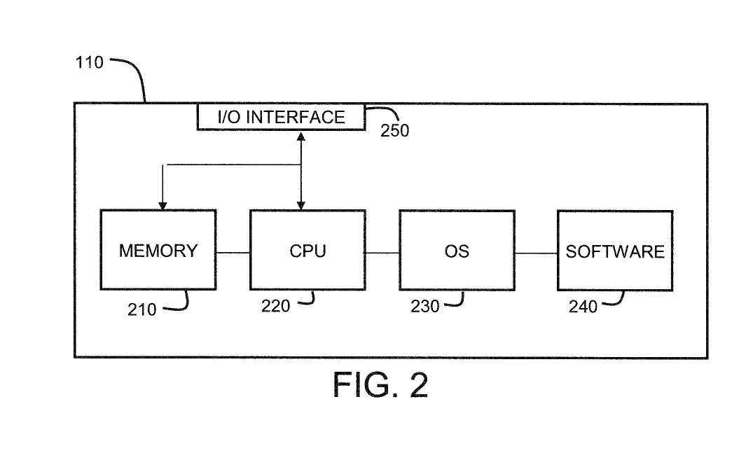

The managing computer system 110 for the payment card service provider 112 as shown in FIG. 2 includes at least one memory device 210 configured to store data that associates identifying information of individual customers, merchants, and transactions associated with payment card accounts. System 110 further includes a computer processor 220, and an operating system (OS) 230, which manages the computer hardware and provides common services for efficient execution of various logic circuitry including hardware, software and/or programs 240. The processor 220 (or CPU) carries out the instructions of a computer program, which operates and/or controls at least a portion of the functionality of the managing computer system 110. System 110 further includes device input/output interface 250 configured to receive and output network and transactions data and information to and/or from managing computer system 110 from and/or to peripheral devices and networks operatively coupled to the system. Such devices may include user 121 and/or merchant 120 terminals, including point of sale (POS) terminals, wireless networks and devices, mobile devices and client/server devices, and user interfaces communicatively coupled over one or more networks for interfacing with managing system 110. The I/O interface 250 may include a query interface configured to accept and parse user requests for information based on the payment card transactions data. In addition, the I/O interface may handle receipt of transactions data and perform transactions based processing in response to receipt of transactions data as a result of a particular purchase via a POS terminal, by way of non-limiting example only.

The at least one memory device 210 may be any form of data storage device including but not limited to electronic, magnetic, optical recording mechanisms, combinations thereof or any other form of memory device capable of storing data, which associates payment card transactions of a plurality of transaction acquirers and/or merchants. The computer processor or CPU 220 may be in the form of a stand-alone computer, a distributed computing system, a centralized computing system, a network server with communication modules and other processors, or nearly any other automated information processing system configured to receive data in the form of payment card transactions from transaction acquirers or merchants 122. The managing computer system 110 may be embodied as a data warehouse or repository for the bulk payment card transaction data of multiple customers and merchants. In addition, the computer system 120 or another computer system 121 (e.g. user computer of FIG. 1) connected to computer system 110 (via a network such as network 130) may be configured to request or query the managing computer system 110 in order to obtain and/or retrieve information relating to categories of customers, merchants, product types deemed purchased and/or services associated therewith, based on information provided via the computer system 120 or 121 and profiling of the transaction data contained in computer system 110 according to the particular query/request.

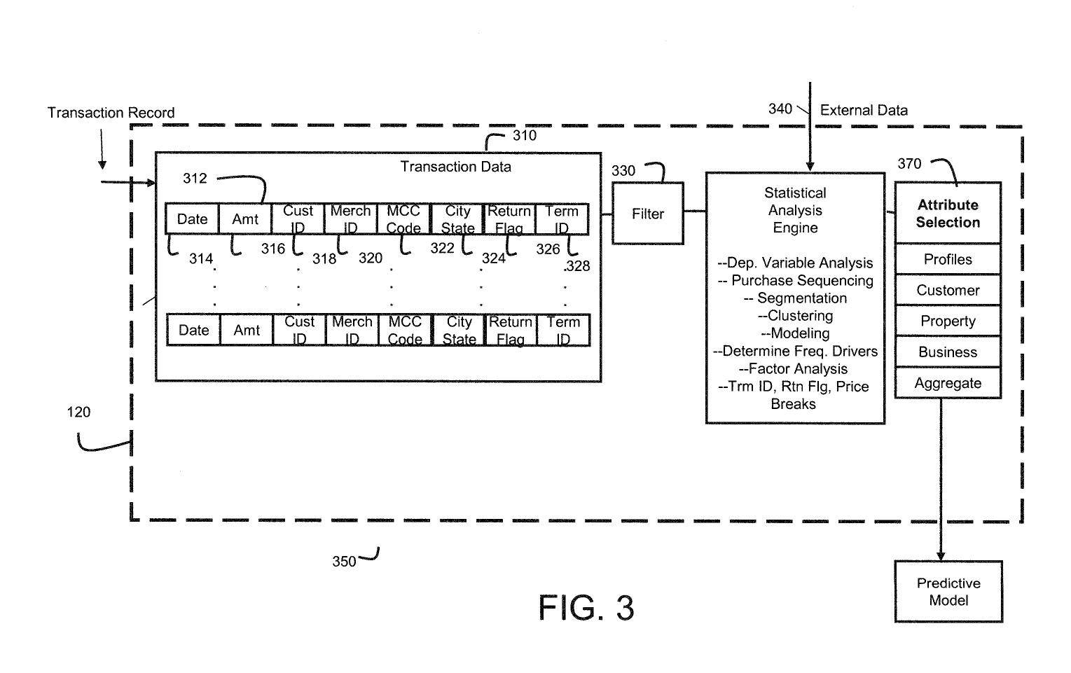

Referring now to FIG. 3, there is shown a system block diagram and operational flow for determining a type or category of item or service purchased (e.g. a type or category of item or product associated with a stock keeping unit or SKU) based on a data base containing payment card transaction data for a multiplicity of customers and merchants, but which does not contain the itemized transaction record information for that particular transaction. The data contained therein may be voluminous and may include years' worth of transaction data associated with a multiplicity of customers and merchants in a wide variety of businesses and geographic regions over a relatively long period of time (e.g. 3-10 years or more).

In one embodiment, the level of granularity associated with the determination of product type or product category may be a function of various factors, including but not limited to, factors such as one or more of purchase price, price breaks between items and/or categories of items, merchant category (e.g. MCC), customer purchasing history, customer and merchant profiles, purchase sequencing, and/or the particular merchant or customer at issue. Further, it is to be understood that the target decision as to a predicted product type or product category may relate to categorical or differential products or services, such as pools, big screen television sets, gaming systems, home theatre installations, automobiles, computers, jewelry, cosmetics, and myriad other product types and categories that the present system and method may use to discriminate (in relation to other products that a particular merchant may sell) based on one or more of the above-identified factors. Implementation of the present disclosure may performed without obtaining personally identifiable (private) data such that the results are not personalized. This enables maintaining privacy of a given user's identity unless the user opts-in to making such data available. In some implementations, the user data is anonymized to obscure the user's identify. For example, received information (e.g. user interactions, location, device or user identifiers) can be aggregated or removed/obscured (e.g., replaced with random identifier) so that individually identifying information is anonymized while still maintaining the attributes or characteristics associated with particular information and enabling analysis of said information. Additionally, users can opt-in or opt-out of making data for images associated with the user available to the system.

Database 310 contains a multiplicity of transaction data associated with managing computer system 110 (FIGS. 1 and 2). The transaction data is configured and processed via an analytics engine 350 to provide intelligent information and profiling of the transaction data for categorizing products, customers, merchants, services, geographic regions, market segments, and purchasing frequencies, by way of non-limiting example. The transaction data 310 in managing computer system 110 is processed and stored in the data base as a series of payment transaction records 312 that associate customer and merchant transaction data. In one embodiment, transaction data may include multiple payment transaction records 312, where each transaction record may include: transaction date 314, transaction amount 316, customer ID 318, merchant ID 320, MCC code 322, geographic region 324 (e.g. city, state, zip code), return flag 326 (indicating if the transaction is a return of merchandise), and terminal ID 328 (indicating the particular terminal of the store at which the transaction occurred).

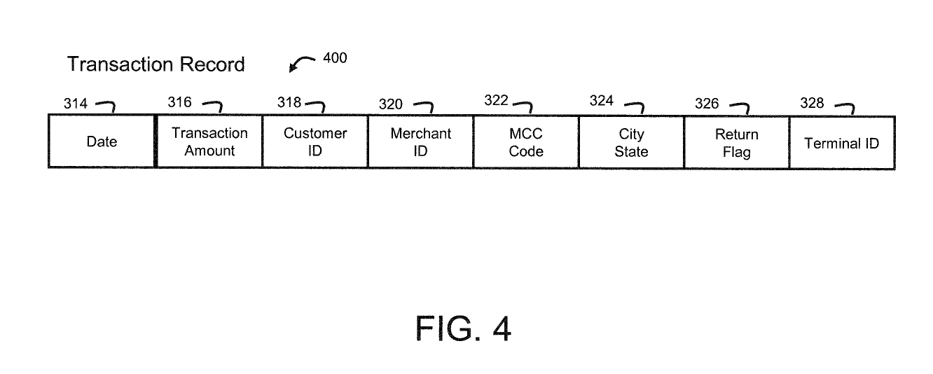

An exemplary transaction record 400 associated with the payment card transaction data received via managing computer system 110 is illustrated in FIG. 4. Customer geography and demographics data may be obtained by modeling of the customer information and may be categorized for example, by local, regional, state, country and/or other geographic or population and statistical boundaries. Merchant information may include information relating to the merchant name, geography, line of business (MCC code), geographic location of the merchant or purchase, the particular terminal of the merchant at which the transaction (POS) was made, information relating to the purchase amount and date of purchase or date of return, date of delivery or service or return, type and the like. This information is utilized by the statistical analytics engine to determine purchasing traits, characteristics and tendencies associated with a particular customer or groups of customers, as well as determine relationships and characteristics associated with product purchasing and purchase amounts per transaction associated with a given customer or groups of customers, in relation to a given merchant or groups of merchants.

More particularly, the transaction data is categorized or grouped by the processor in a plurality of ways so as to decompose or break down the various informational components of the transaction data collected within the database. Payment card transaction data 310 stored in managing computer system 110 may be filtered 330 according to the requirements of a particular application in order to selectively identify specific customers, merchants and/or industries for targeted analysis. Filtering of the data may be based on one or more of transaction purchase price (amount), merchant identifier, and terminal identifier associated with the particular merchant terminal at which the transaction was made. Filtering of the data based on time sequencing of transaction events and temporal intervals (e.g. last five years' data, seasonal date ranges, etc.), may be applied to further target particular aspects of the transaction data for given applications. In one non-limiting example, the transaction data may be augmented with external data 340 (e.g. non-payment card transaction data). The external data may reside within the same transactions data base or may be linked in a separate date base, by way of non-limiting example.

The payment card transactions records 312 may be obtained via various transaction mechanisms, such as credit and debit card transactions between customers and merchants. The external data 340 that may optionally be included in the transactions data may include samples of itemized or detailed receipts which identify specific products (and even SKUs), itemized or detailed receipts relating customer and merchant accounts with specific items purchased, dates, and locations, organizational characteristics and features of a business (firmographics) useful for segmenting markets (market research), and other relevant market data relating to one or more services, customers, and merchants contained in the transaction data. Such data may operate to link customers and merchants with particular purchases of products or services within a given transaction. Additional information such as transaction data relating to on-line purchase transactions vs. in-person purchase transactions may also be included.

Analytics engine 350 operates on the transaction data by performing statistical analyses in order to construct logical relationships within and among the transactions records data in order to determine particular properties purchased (e.g. cars, boats, gasoline purchases, oil burning water heaters, etc) as well as relationships between different purchase transactions in order to predict products purchased without the benefit of direct itemization information. Various types of models and applications may be configured and utilized by analytics engine 350 in order to derive information from the transactions data. Further statistical processing of the transaction data includes independent variable analysis purchase sequencing, segmentation, clustering, ranking, and parameter modeling, to establish profiles, trends and other attributes and relationships that link merchants, customers, events and transaction amounts to various purchases or returns. For example, the analysis engine operates on the transactions records to cluster or group certain sets of objects (information contained in the data records) whereby objects in the same group (called a cluster) express a degree of similarity or affinity to each other over those in other groups (clusters).

Further statistical and variable analysis processing 370 is utilized in order to ascribe attributes to purchasers of a given transaction. Variables such as time, purchase frequency, purchasing geography and location, aggregate customer spending, and the like may be used to develop profiles for particular transaction events, merchants, and customers, as well as more generalized aggregate profiles directed to classes or categories of products purchased, merchants, customers, and regions, as well as overall information falling within a particular goods or services category.

Data segmentation of the transactions data associated with analytics engine 350 includes dividing customer information (e.g. customer IDs) into groups that are similar in specific ways relevant to other variables or parameters such as geographic region, spending preferences, customer type (e.g. individual consumer or business), demographics, and so on. By way of example only, variables may be defined according to different merchant categories and may have different degrees of correlation or association based on the type or category of merchant. Similarly, different products and/or services of particular merchants may likewise have different degrees of correlation or association. Furthermore, variable analysis of purchasing frequency with respect to particular products and/or merchants may also be utilized as part of the analytical engine 350 in order to determine particular consumers who purchase a given property.

The profiles and attributes from block 370 may be applied to one or more particular customers 382, merchants or service providers 384, markets 386, and other applications 388 in order to provide particular insights for a select application. Such applications include by way of non-limiting example, providing enhanced product information to a third party with predicted goods and services purchased in a particular sales transaction tailored to each particular customer in view of overall customer transaction data. Additional applications may be directed to customer prospecting, customer relationship management, service interval predictions and reminders, as well as comparative profiling and evaluation of merchant and/or market costs of particular goods and services.

Data modeling may be used to develop, define, and update certain attributes and behaviors of purchasers based on classifications of purchasers and their actual purchased products. As data is collected by the system based on the transaction records, the predictive model operates to infer that a certain product was purchased in a given transaction, without itemization of that transaction. Validation of the probability modeling may be obtained by feeding data transaction records into the system (e.g. test data) that contain, customer, merchant, transaction amount, and terminal ID information (devoid of direct itemization), determining from the data and historical analytical processing a likelihood indicator that each transaction represented a particular type or category of product purchased, and then comparing the predicted values with actual data (e.g. external data such as merchant data) representing the actual products purchased in each of the transactions. Based on the comparison in view of the prior predictions, factors that influence the predictive model may be altered or updated to better enhance and refine the quality of the predictive model.

Each or any combination of the modules and components shown in FIG. 3 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 3, these modules may perform functionality described later herein.

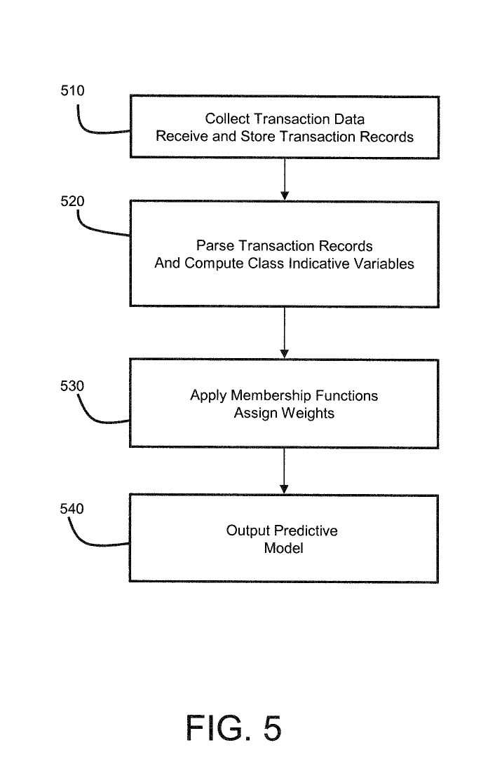

Referring now to FIG. 5 in conjunction with FIG. 3, there is illustrated a system and process flow for transaction data to determine a type or class of goods and/or services that are purchased and/or returned in a particular transaction, without the benefit of direct itemization of the transaction. More particularly, in an exemplary embodiment, transaction data 310 (FIG. 3) is received and collected 510, being stored as transaction records 312 (FIG. 3). Specific transaction records 312 are identified and parsed to identify and compute variables which may be indicative of a class of good that was purchased or returned in the identified transaction 520. For example, a sales transaction may occur in which the consumer uses a payment card to remit payment for one or more goods as part of a sales transaction. Transaction data relating to the payment card transaction is transmitted to a payment card processing system. By way of non-limiting example, the transaction data includes information which identifies one or more of the customer, the merchant, the date and/or time of the transaction, a merchant type, a customer type, a flag to indicate if the transaction is a return or a sale, and a terminal ID to indicate the terminal at which the payment card was swiped to process the transaction. It is understood that the transaction record data received may include or exclude one or more of the above items, and/or may include additional items. However, the card processing system receives no information as to the specific goods (items) purchased or returned in the transaction. Rather, the card processing system merely receives a total transaction amount which is processed to be debited (added) to the identified merchant's balance, and credited to the purchaser as an increase in the consumer's balance due in the case of a credit card, or a reduction in the consumer's account balance in the case of a debit card. The merchant is in a position to know the goods and services purchased through transaction details captured at the point of sale. However, for other purchases made (e.g. purchases at competing business locations), such detailed information is not available to the merchant. In any case, the card processing system is not aware of the specific number or classes of items represented in a given sales transaction. Nevertheless, these transactions, embodied as a plurality of transaction records, include certain information which may shed light on the class of goods and services in a particular transaction based on analysis and comparison to similar transactions stored in the transaction data 310.

As a non-limiting illustration, consider a customer who enters a big-box type electronics store and makes a substantial purchase costing $750.00. The consumer presents a payment card at the merchant point of sale (POS) terminal, such as a cash register to pay for the item(s) purchased. The transaction records processed over the payment card network and analyzed by the system may include one or more of the customer card number (Customer ID), the date and possibly the time of the transaction, the Merchant ID, and the Terminal ID of the POS terminal where the sale was processed and the total amount of the transaction. The transaction is processed and upon receiving the transaction information, the card processing system stores the transaction information as a transaction record in managing computer system 110 (FIG. 1). Other information may be included in the transaction data, such as whether the transaction is a sale or a return. A return flag may be added to the transaction record 312 to indicate the status of the transaction. The return flag may be included as part of the transaction data submitted by the merchant, or it may be determined at the card processing system based on whether the transaction amount is a positive or a negative value. The category or classification of the merchant may also be determined by the card processing system and included in the transaction record (e.g. MCC code), which may serve as an indication of the class of merchant processing the sale.

Based on the data in each transaction record, a number of type-indicating variables may be determined. For instance, the class of merchant (e.g. a big-box electronics store) may give insight into the general class or category of goods and services. Additionally, the amount of the transaction may provide information for identifying or predicting the item purchased in the transaction.

Consider, for example, a merchant who operates an automobile dealership. A sales transaction that amounts to thousands of dollars may be indicative of a car purchase, while a transaction for less than fifty dollars, would not indicate a likelihood of a car purchase. Rather, such transaction amount may be indicative of a simple service such as an oil-change. While a single transaction may not be informative as to the specific nature of a purchased product, considering the transactions of numerous purchasers at numerous merchants of the same type may provide information that is used to infer the class of goods or services that are the subject of a particular transaction. Statistical analysis of the data by the analysis engine of the managing computer system enables determination of sets of price thresholds corresponding to clusters of transaction purchase prices and allocated to a corresponding category or type of item for offered for sale by the merchant. In another exemplary embodiment, the system may be configured to analyze the transaction record data such that knowledge as to the specific merchant and/or cardholder is not required in the transaction data in order to generate an itemized (product) prediction. For example, for a given transaction record that includes the transaction amount and the merchant category/classification (e.g. MCC code), the system may be able to predict the type or category of product purchased in the transaction. For example, based on historical data associated with transactions corresponding to the automobile industry, even dollar amounts (e.g. $500, $1,000, $5,000, etc.) generally describe vehicle purchases, in contrast to other possible purchases associated with that category of merchant (e.g. repairs or vehicle component/accessory purchases which tend not to be rounded). Such characteristics or traits associated with the historical data for a given merchant category may be stored in a rules data base within the analytics engine. In such a case, the system may be configured, based on determination of the merchant category (e.g. automobile dealership) and transaction amount (e.g. $4,500—round or even number) to predict that the transaction was a vehicle purchase. Thus, the particular customer or merchant historical data may not be needed in order to generate a prediction because historical profiles and analyses using the merchant's category and analysis of the merchant category's historical transaction amounts (to discriminate between categories of products) may be employed.

In addition, the analysis engine utilizes temporal sequencing of transaction data associated with a particular customer to further distinguish and allow inference of a particular class of item sold in the transaction. For example, if the electronics consumer discussed above who spent $750 at the big-box electronics store is identified as executing subsequent (or precedent) transactions soon after (or before) the big-box purchase, such as spending $150 at a video game store, and spending $25 for a subscription to a gaming magazine, it may be inferred that the $750 spent at the big-box electronics store was used to purchase a video gaming system. Sequential data analysis may be applied to individual populations or demographics to determine what types of purchases these groups of individuals make.

For example, 10 years of purchase data may be used to identify sales indicators that occur within 6 months of a triggering event. For example, if the transaction of buying a car is identified in a dataset spanning ten years, the individuals making car purchases along with their other purchases before and/or after the sale may indicate what the population generally buys within six months of buying a new car. Once such patterns are identified, particular individuals may be identified as to the likelihood that he/she is going to buy that item or not.

In another example, the terminal ID provided with the transaction data may be used to provide information as to the class of goods or services based on identifying the particular point of sale represented by the terminal ID. This is particularly relevant for a merchant such as a department store. In a department store, goods are typically segregated by class of goods into different departments. Each department generally has one or more POS terminals for processing sales within that department. Using analytical processing to correlate various transactions to a particular terminal ID or group of terminal IDs, the particular department (e.g. men's clothing, women's clothing, children's clothing, jewelry, cosmetics, etc.) associated with the terminal ID may be determined. Once the department in known, it becomes a simpler determination of the class of goods or services due to the restriction of the inquiry to goods generally offered in the identified departments. Furthermore, once the department associated with terminal ID is identified, transactions may be identified and processed with regard to amounts. When analyzing transaction amounts for a given terminal, patterns may be identified by the analytics engine that define natural breaks which allow inference of the class of goods being sold.

For example, assume a terminal is observed to have a large number of purchases for a small dollar figure (e.g. less than $10), a large number of purchases for moderate dollar figures (e.g. between $50 and $100), and a small number of transactions for “big ticket” items (e.g. transactions greater than $1,000). The gaps between these price ranges are known as natural breaks. If the terminal is associated with a perfume and jewelry counter, distinctions may be inferred based on the natural breaks between price groupings. For example, the system may be configured to identify distinctions between a fine jewelry purchase, versus a perfume purchase, versus a purchase of jewelry cleaning solution.

Referring again to FIG. 5, when the class identifying variables have been identified and computed, an associating function is applied to identify transaction records that can be associated with a particular identifying variable. For example, an identifying variable may be a merchant type (e.g. hardware store). Transaction records which are generated from transaction data submitted to the card payment system by merchants identified as hardware stores can be associated and analyzed as a group. Within the associated group or class of merchant, weights are assigned by the engine to each transaction record 530 that correspond to the likelihood that the purchase that created the transaction data identifies a particular good(s) associated with the identified merchant type. For example, based on the amount of the transactions and the season in which they occur, it may be possible to identify the goods as lawn mowers being purchased from the population of hardware stores. Using the calculated weights, the probability that a particular transaction identifies a particular item may be analyzed. For example, a threshold likelihood value may be established as sufficient to identify a particular item type or category as that purchased in the transaction. If the probability of a certain transaction exceeds the threshold for a particular item type or category, the transaction may be identified as involving that particular item.

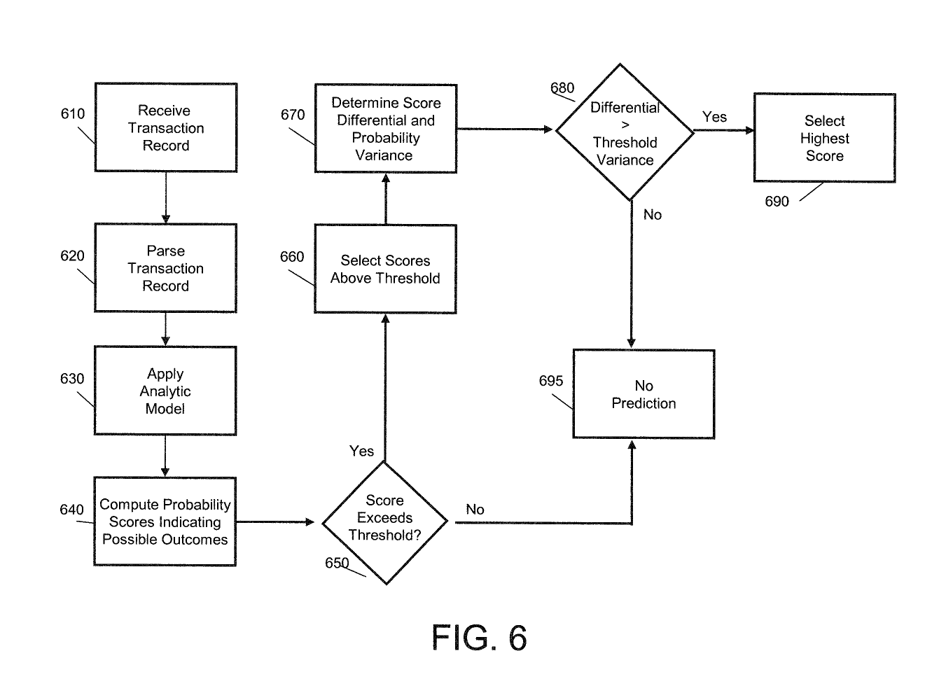

FIG. 6 is a block process flow diagram for determining a likelihood that a specific transaction involves a particular item according to an embodiment of the disclosure. A transaction record is received 610 from the managing computer system 110 (FIG. 1). The received transaction record is then parsed 620 to identify characteristics of the transaction, including sequential data relating to other transactions involving other customers, merchants, dates, geographic regions and amount. An analytic model is applied to the transaction data in the parsed transaction record as well as the transaction data received in other transactions sharing at least a portion of the identified characteristics of the parsed transaction record 630. Based on the amount of the transaction and other data relating to the merchant, such as the class of a particular merchant, or the demographic of the customer associated with the transaction, probability scores are computed for the transaction. Each probability score represents a likelihood that the transaction was a sale of a particular item type or category 640.

The probability is compared to a score threshold 650 to determine if the likelihood that the transaction involves a particular item is higher than a baseline likelihood. If the scores do not exceed the threshold relating to each item type considered, then no prediction is made 695. If one or more scores exceed the threshold for an associated item, the scores that exceed the threshold value are selected for further analysis 660. The differential of the selected scores is determined along with a threshold variance for the probability of each score 670. If the score differential exceeds the threshold variance 680, then the highest score is selected 690, and the score's associated item type or category is identified as the object of the transaction. If the differential does not exceed the threshold variance, then no prediction is made 695.

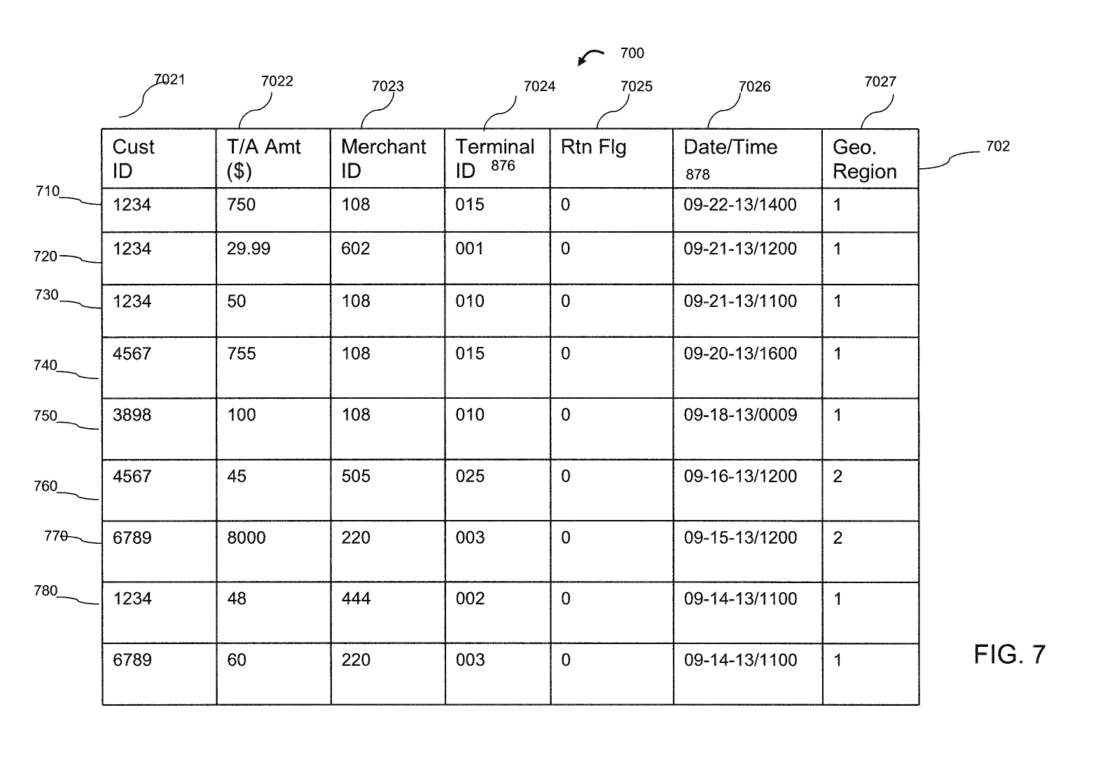

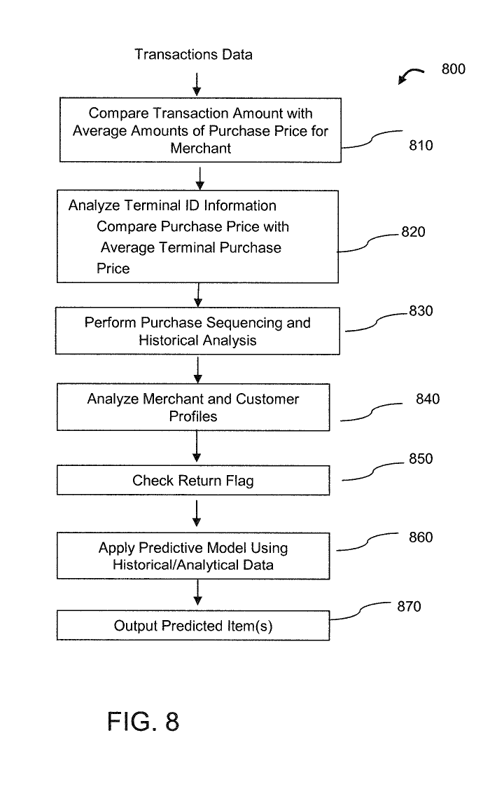

FIG. 7 illustrates exemplary data base transactions data 700 on which the system and method of the present disclosure operate for determining a type or category of product purchased as part of a payment card transaction 710 between a customer and a merchant that omits direct itemization. FIG. 8 illustrates exemplary processing functionality that may be performed by the system for determining a type or category of product purchased as part of the payment card transaction depicted in FIG. 7.

As shown in FIG. 7 in conjunction with FIG. 8, a given transaction 710 is stored in the transactions data base, along with a multitude of other transaction records labeled as 720, 730, 740, and so on. Each transaction record includes field columns 702 as shown. By way of example, after transaction record 710 is received and stored in the transactions data base, processing may be performed to determine where the transaction amount falls within natural breaks associated with spending associated with the particular merchant. For example, a particular transaction amount 7022 is compared with an average purchase amount for the particular merchant to assess whether the transaction may be categorized as a low, mid or high ticket transaction, based on the merchant product pricing and associated customer (block 810).

The terminal ID field 7024 is also analyzed (block 820) and the transaction purchase price 7022 is compared with an average terminal purchase price associated with the particular terminal ID for the given merchant 7023, based on historical transactions data. In some instances, particular stores have terminals located at different parts of the store (e.g. terminals 015 and 010 of big box electronics merchant ID 108) and tend to process different transaction amounts due to different product categories or types. Comparison yields data indicating whether the particular transaction falls within or outside the range of one or more average transaction amounts associated with the particular merchant terminal. That is, for a given terminal ID, historical transactions data compiled for the particular terminal and merchant may yield associations of particular categories or types of purchases, and hence corresponding price amounts. For example, based on statistical analysis, the particular terminal ID 015 for merchant 108 (e.g. big box electronics store) may yield an average purchase price in the range of $700-$1500. Further, based on statistical sampling, as well as possibly external data such as price listings of the merchant, advertisements, data feeds, previously supplied merchant data, and the like, particular product or item listings or categories are associated with that terminal. For example, statistical analysis and predictive modeling (block 860) indicates that terminal ID 015 for big box electronics merchant represents a mid range ticket price for that merchant/terminal combination. Based on the merchant's product listing and product prices, gaming systems and computers represent the two categories that tend to be most associated with this terminal ID. In this example, based on the historical data and statistical analysis of the transaction data, analysis of the price differences between the given transaction price and the average terminal ID price provide insight into whether a given transaction may be determined according to the product types or categories associated with a given terminal ID. In this instance, because the transaction amount falls within the range predicted for both a gaming product and a computer, both categories are viable (as opposed to other categories, such as home theatre systems, whose price threshold exceeds that of the transaction, or ancillary equipment such as cables or small electronic devices, whose price threshold is less than that of the transaction).

In addition, purchase sequencing (block 830) and historical analysis of prior transaction purchases (and/or subsequent transaction purchases) is performed in order to obtain further information to aid in predicting the likelihood of a particular category or type of item purchased. For example, FIG. 7 shows that customer 1234 made several purchase transactions (in addition to the $750 transaction under examination at big box electronics) within a few days of one another. These transactions are shown conducted with merchant ID 602 (game store) in an amount of $29.99, merchant ID 444 (on-line gaming magazine) in the amount of $48, and merchant ID 108 (big box electronics) in the amount of $50 at terminal ID 010. Merchant and customer profiles (block 840) are used to determine tendencies and traits regarding the types of products purchased, both for the particular customer as well as in aggregate for a given profile. Purchase sequencing may be limited to a particular time interval, depending on the particular application. Weights may be assigned based on the likelihood or confidence in the predictive nature of a given decision.

Continuing with the present example, analysis of the transaction purchase sequencing, purchase prices, merchant/terminal IDs, and transaction date/time, the processing concludes that transaction 780 represented a gaming magazine subscription, transaction 720 represented a computer game purchase, and transaction 730, although not necessarily determinative of a given product, represented a relatively low end purchase. Other customer data may also be examined to assist in making a determination regarding a different customer. For example, customer ID 4567 and 1234 are included in the same aggregated customer profile and tend to exhibit similar purchase/spend activities. In this case, analysis of the transactions data indicates a likelihood that both purchased the same item (710, 740), with a greatest likelihood of the item being a game station, based on the transactions data and predictive model. Information concerning the determined item may be output (block 870) to third parties interested in providing advertisements and/or other information relating thereto. Although the predictive model may also provide a likelihood indicator that the particular category of product purchased in transaction 710 was a computer, the higher value likelihood indicator represents a game station. Additional factors in predicting certain products for a given transaction include checking the return flag (block 860) and analyzing history data to determine the nature of the return and of the original product purchase and/or new product purchased. The terminal ID may be checked in relation to the original transaction as well as the return, in addition to the transaction return amount and original purchase amount. Refunds from other stores of the same merchant or similar merchants may also be analyzed to determine a likelihood of a given category or type of item.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

1. A method for determining a type or category of product purchased as part of a payment card transaction between a customer and a merchant, the method comprising:
receiving at a computer processor, payment card transaction record data including at least one of a customer identifier, a merchant identifier, and a transaction purchase amount corresponding to a product purchase transaction, the transaction record omitting direct product purchase itemization data;
determining, using a predictive model, a likelihood indicator that a given type or category of product sold by the merchant matches that of the actual product purchased in the payment card transaction, by analyzing the transaction record data and comparing with historical data of previous payment card transactions, to generate one or more score indicators that represent different possible product types or categories of product purchased in the payment card transaction;
comparing the one or more score indicators with a threshold value to generate a score index; and
selecting the indicator having the highest score from the score index as representative of the type or category of product actually purchased in the transaction.

2. The method of claim 1, wherein the determining step further comprises comparing the price of the product purchase transaction with one or more predetermined price thresholds associated with a merchant spend profile, wherein a given category or type of product for purchase by the merchant is associated with a corresponding price threshold.

3. The method of claim 1, wherein said determining step further comprises receiving terminal identifier information in said transaction record representing the terminal at which said transaction occurred, and comparing the purchase price amount of said transaction record with an average purchase price transaction amount associated with said terminal.

4. The method of claim 3, further comprising determining average purchase transaction amounts for each terminal identifier of a given merchant, and comparing said terminal average purchase amounts to allocate categories or types of products purchased with each of said terminals of said merchant.

5. The method of claim 1, wherein said determining a likelihood indicator further comprises performing temporal purchase sequencing of transactions of said customer over a given time interval and correlating the transaction record data to determine a trend of customer behavior indicative of the likelihood that a given category or type of product sold by the merchant is representative of the type or category of product purchased in the transaction.

6. The method of claim 1, wherein said determining a likelihood indicator further comprises determining natural price breaks associated with a merchant based on computerized analysis of aggregate purchase price transaction records associated with a particular merchant.

7. The method of claim 1, wherein analyzing the transaction record data further includes analyzing the customer identifier, the transaction purchase amount, and a class of the merchant corresponding to said transaction record, and comparing with historical data of previous payment card transactions of at least one of the customer and merchant, to generate said one or more score indicators that represent different possible product types or categories of product purchased in the payment card transaction.

8. A system for determining a type or category of product purchased as part of a payment card transaction between a customer and a merchant using payment card transaction data that omits direct product itemization data for said transaction, the system comprising:
one or more data storage devices containing payment card transaction data of a plurality of customers and merchants, the payment card transaction data including customer information, merchant information, and transaction amounts and omitting direct product itemization data for said transactions;
one or more processors;
a memory in communication with the one or more processors and storing program instructions, the one or more processors operative with the program instructions to:
receive at a computer processor, payment card transaction record data including at least one of a customer identifier, a merchant identifier, and a transaction purchase amount corresponding to a product purchase transaction, the transaction record omitting direct product purchase itemization data;
determine, using a predictive model, a likelihood indicator that a given type or category of product sold by the merchant matches that of the actual product purchased in the payment card transaction, by analyzing the transaction record data and comparing with historical data of previous payment card transactions, to generate one or more score indicators that represent different possible product types or categories of product purchased in the payment card transaction;
compare the one or more score indicators with a threshold value to generate a score index; and
select the indicator having the highest score from the score index as representative of the type or category of product actually purchased in the transaction.

9. The system of claim 8, wherein the one or more processors is operative to compare the price of the product purchase transaction with one or more predetermined price thresholds associated with a merchant spend profile, wherein a given category or type of product for purchase by the merchant is associated with a corresponding price threshold.

10. The system of claim 8, wherein the one or more processors is operative to receive terminal identifier information in said transaction record representing the terminal at which said transaction occurred, and compare the purchase price amount of said transaction record with an average purchase price transaction amount associated with said terminal.

11. The system of claim 8, wherein the one or more processors is operative to determine average purchase transaction amounts for each terminal identifier of a given merchant, and compare said terminal average purchase amounts to allocate categories or types of products purchased with each of said terminals of said merchant.

12. The system of claim 8, wherein the one or more processors is operative to determine a likelihood indicator by performing temporal purchase sequencing of transactions of said customer over a given time interval and correlating the transaction record data to determine a trend of customer behavior indicative of the likelihood that a given category or type of product sold by the merchant is representative of the type or category of product purchased in the transaction.

13. The system of claim 8, wherein the one or more processors is operative to determine a likelihood indicator by determining natural price breaks associated with a merchant based on computerized analysis of aggregate purchase price transaction records associated with a particular merchant.

14. The system of claim 8, wherein the one or more processors is configured to analyze the transaction record data including the customer identifier, the transaction purchase amount, and a class of the merchant corresponding to said transaction record, and compare with historical data of previous payment card transactions of at least one of the customer and merchant, to generate said one or more score indicators that represent different possible product types or categories of product purchased in the payment card transaction.

15. A system for analyzing payment card transactions data comprising:
an input module for receiving a transaction record including at least one of a customer identifier, a merchant identifier, and a transaction amount, corresponding to a product purchase transaction, the transaction record omitting direct product purchase itemization data;
a database for storing the transaction record received by the input module;
a computerized predictive model for determining a likelihood indicator that a given type or category of the product purchased as part of the transaction, based on at least one of the customer identifier, transaction amount, a class of merchant, and a terminal identifier, wherein the indicator is indicative of a likelihood of a correct product determination; and
one or more computer processors for:
executing the predictive models; and
processing the transaction record based upon the indicator determined by the computerized predictive model.

16. The system of claim 15, wherein the computerized predictive model is constructed through an analytic process that identifies variables in a plurality of transaction records corresponding to a sale, and calculates at least one score based on analysis of said variables, wherein each score is indicative of a likelihood that the transaction record corresponds to a purchase of a particular good or service.

17. The system of claim 16, wherein the one or more processors aggregate transaction records to generate one or more merchant and customer profiles that associate the product categories of a given merchant with an average product price and average transaction amount.

18. The system of claim 16, wherein the one or more processors determines a variance threshold for a differential in scores that exceed the score threshold, and selects a highest score from scores whose differential exceeds the variance threshold.

19. The system of claim 18, wherein the one or more processors executing said predictive model identifies the transaction record and its corresponding product purchase as being a purchase of a particular type or category of item based on the selected highest score.
